(19) United States
(12) Patent Application Publication
(10) Pub. No.: US 2022/0287486 A1
(43) Pub. Date: Sep. 15, 2022

(54) RAPID BEVERAGE COOLING DEVICE AND REFRIGERATION METHOD THEREOF

(71) Applicant: XIAOFENG LIU, FOSHAN CITY (CN)

(72) Inventor: XIAOFENG LIU, FOSHAN CITY (CN)

(21) Appl. No.: 17/318,127

(22) Filed: May 12, 2021

(30) Foreign Application Priority Data
Mar. 13, 2021 (CN) 202110272764.6

(51) Int. Cl. A47G 19/22; A47J 41/00; F25D 31/00

(52) U.S. Cl. CPC A47G 19/2288; A47J 41/0044; A47J 41/0094; A47G 19/2205; F25D 31/002; A47J 2203/00

(57) ABSTRACT

A rapid beverage cooling device and a refrigeration method thereof are provided. The rapid beverage cooling device includes an outer cup body and an inner cup body of which rims are connected. An interlayer inner cavity for storing a liquid is formed between the outer cup body and the inner cup body; a liquid injection port communicated with the interlayer inner cavity is made at a bottom of the outer cup body; the liquid injection port can be opened or sealed; a liquid accommodating cavity is disposed in the inner cup body; a convex column extends toward the liquid accommodating cavity from a wall of the inner cup body; and an inner cavity of the convex column is communicated with the interlayer inner cavity.

### FIELD OF THE DISCLOSURE

The present disclosure relates to the field of rapid cooling devices, and more particularly to a rapid beverage cooling device and a refrigeration method thereof.

### BACKGROUND OF THE DISCLOSURE

In daily life, consumers like to drink ice-cold beverages such as ice-cold coffee, juice, coca cola and beer. In order to drink an ice-cold and refreshing beverage immediately, they often add ice cubes directly into the beverage for rapid cooling. However, since the ice cubes are molten into liquid water and mixed with the beverage, the concentration of the beverage will be reduced to affect the taste.

Therefore, a freezer mug for rapidly cooling a beverage with the beverage separated from ice cubes is commercially available. The structure of the freezer mug, as shown in FIG. 1, mainly includes a cup casing 1, a large cup 2, a small cup 3 and a cup lid 4. In use, an appropriate amount of clear water is poured into the cup casing; next, the small cup is filled with clear water and spirally connected to the cup lid; then, the large cup is sleeved on the periphery of the small cup and also connected to the cup lid; after that, the cup lid connected to the small cup and the large cup is connected to an opening of the cup casing so that a liquid accommodating cavity for accommodating a beverage is formed between the small cup and the large cup; and finally, the freezer mug is put into a freezing apparatus such as a refrigerator to freeze the clear water. This structure is complex, with many accessories and complicated mounting and connection, resulting in high manufacturing cost and inconvenience in storage. Further, in use, a beverage is added through a water inlet 41 on the cup lid, and after the beverage is made to fully contact with the walls of the small cup and the large cup, the cooled beverage is poured out from a water outlet 42 on the cup lid. However, in a freezing process of the freezer mug with this structure, because when the water is cooled and transformed into ice, its volume is increased, and all cavities full of clear water are all in a sealed state, so that there is no enough space for expansion and pressure relief during the transformation of the water into ice, the freezer mug is very likely to burst to cause product damage and even safety accidents.

### SUMMARY OF THE DISCLOSURE

An objective of the present disclosure is to solve the above-mentioned existing problem and provide a rapid beverage cooling device with a simple and reasonable structure, and a refrigeration method thereof. The device is used for rapidly cooling a beverage, and has a large freezing storage capacity and a large freezing area; moreover, in an ice making process of the rapid cooling device, the burst of the rapid cooling device caused by volume increase can be prevented during the transformation of the water into ice.

A rapid beverage cooling device includes an outer cup body and an inner cup body of which rims are connected, wherein an interlayer inner cavity for storing a liquid is formed between the outer cup body and the inner cup body; a liquid injection port communicated with the interlayer inner cavity is made at a bottom of the outer cup body; the liquid injection port can be opened or sealed; a liquid accommodating cavity is disposed in the inner cup body; a convex column extends toward the liquid accommodating cavity from a wall of the inner cup body; and an inner cavity of the convex column is communicated with the interlayer inner cavity.

The present disclosure also can be made by the following technical measures:

Further, a cover body member for closing the interlayer inner cavity is mounted on the liquid injection port.

Further, the outer cup body includes a cup side wall, a lower opening for completely opening a bottom of the interlayer inner cavity is disposed at a bottom of the cup side wall, and the lower opening forms the liquid injection port; or the outer cup body includes a cup side wall and a cup bottom wall, a through hole for communicating the interlayer inner cavity with the outside is formed on the cup bottom wall, and the through hole forms the liquid injection port.

Further, the cover body member includes a screw cap with an internal thread, or an elastic seal plug; an external thread fitting an internal thread is disposed on the cup side wall; the screw cap is spirally connected to the lower opening by screw-thread fit; and the seal plug is mounted in the through hole.

Further, the convex column extends toward the liquid accommodating cavity from the bottom wall of the inner cup body or/and the side wall of the inner cup body.

Further, at least one convex column matching a shape of the liquid accommodating cavity extends from the bottom wall of the inner cup body.

Further, a plurality of convex columns extend toward the liquid accommodating cavity from the bottom wall of the inner cup body; and the convex columns are distributed in a rectangular array or an annular array.

Further, a maximum liquid level line is disposed on walls of the outer cup body and the inner cup body and corresponding to the interlayer inner cavity.

Further, a handle is disposed on an outer end surface of the outer cup body.

A refrigeration method of the rapid beverage cooling device includes the following steps:

step 1, turning the rapid cooling device upside down to make the liquid injection port face upward;

step 2, adding drinking water into the interlayer inner cavity through the liquid injection port to a maximum liquid level line or below the maximum liquid level line;

step 3, putting the rapid cooling device, with the liquid injection port facing upward, into a refrigeration apparatus for cooling;

step 4, waiting for the liquid in the interlayer inner cavity to be cooled to a frozen state;

step 5, taking the rapid cooling device out of the refrigeration apparatus;

step 6, mounting the cover body member on the liquid injection port to seal the interlayer inner cavity; and

step 7, pouring a beverage into the liquid accommodating cavity for cooling.

The present disclosure has the following beneficial effects:

For the rapid beverage cooling device and the refrigeration method thereof provided by the present disclosure, the structure is simple, and the production is convenient and efficient. In the rapid cooling device with this structure, the contact area between a beverage and the rapid cooling device can be increased by the convex column so that the beverage can be rapidly cooled; in addition, in an ice making process of the rapid cooling device, because of the provision of the liquid injection port and the refrigeration method of the rapid cooling device in which the rapid cooling device is turned upside down to make the liquid injection port face upward and the water can expand along the liquid injection port during expansion while condensing into ice, thereby effectively avoiding the burst of the rapid cooling device caused by volume increase

### BRIEF DESCRIPTION OF THE DRAWINGS

FIG. 1 is a schematic diagram of a structure according to the prior art of the present disclosure.

FIG. 2 is a schematic diagram of a structure according to a first embodiment of the present disclosure.

FIG. 3 is a schematic diagram of a structure according to a second embodiment of the present disclosure.

FIG. 4 is a schematic diagram of a structure according to a third embodiment of the present disclosure.

FIG. 5 is a first schematic diagram of a structure of a convex column of the present disclosure.

FIG. 6 is a second schematic diagram of a structure of the convex column of the present disclosure.

FIG. 7 is a schematic diagram of the service state of the present disclosure.

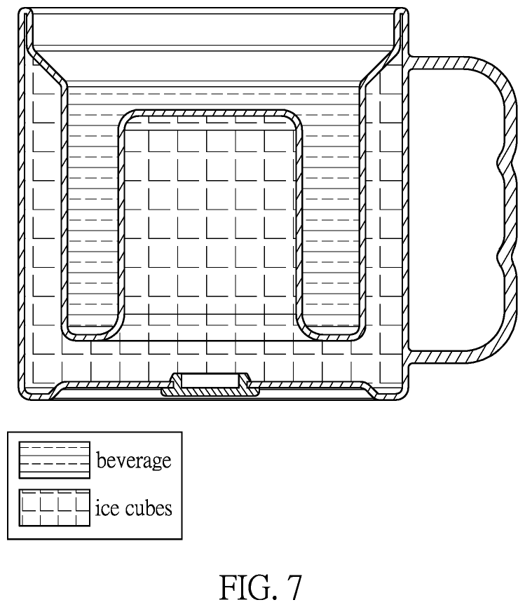

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure is further described below with reference to accompanying drawings and embodiments.

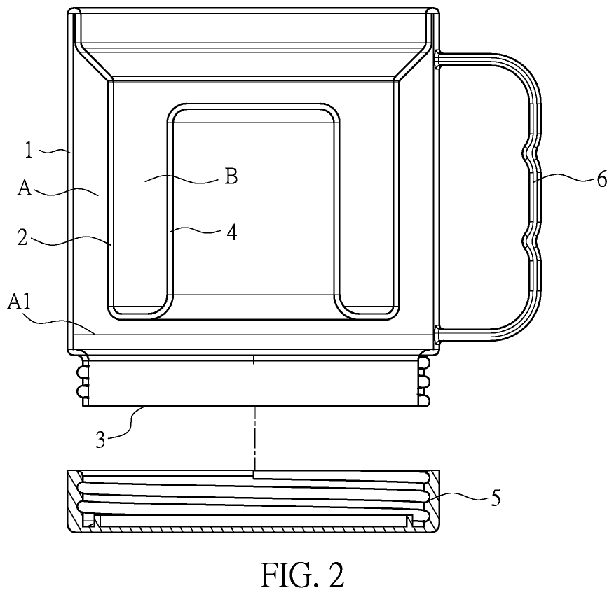

First Embodiment: As shown in FIG. 2, a rapid beverage cooling device includes an outer cup body 1 and an inner cup body 2 of which rims are connected. An interlayer inner cavity A for storing a liquid is formed between the outer cup body 1 and the inner cup body 2; a liquid injection port 3 communicated with the interlayer inner cavity A is made at a bottom of the outer cup body 1; the liquid injection port 3 can be opened or sealed; a liquid accommodating cavity B is disposed in the inner cup body 2; a convex column 4 extends toward the liquid accommodating cavity B from a wall of the inner cup body 2; the inner cavity of the convex column 4 is communicated with the interlayer inner cavity A; and a cover body member 5 for closing the interlayer inner cavity A is mounted on the liquid injection port 3. In the rapid cooling device with this structure, the contact area between a beverage and a freezing part of the rapid cooling device can be increased by the convex column so that the beverage can be rapidly cooled; in addition, in an ice making process of the rapid cooling device, because of the provision of the liquid injection port and the refrigeration method of the rapid cooling device in which the rapid cooling device is turned upside down to make the liquid injection port face upward and the water can expand along the liquid injection port during expansion while condensing into ice, thereby effectively avoiding the burst of the rapid cooling device caused by volume increase.

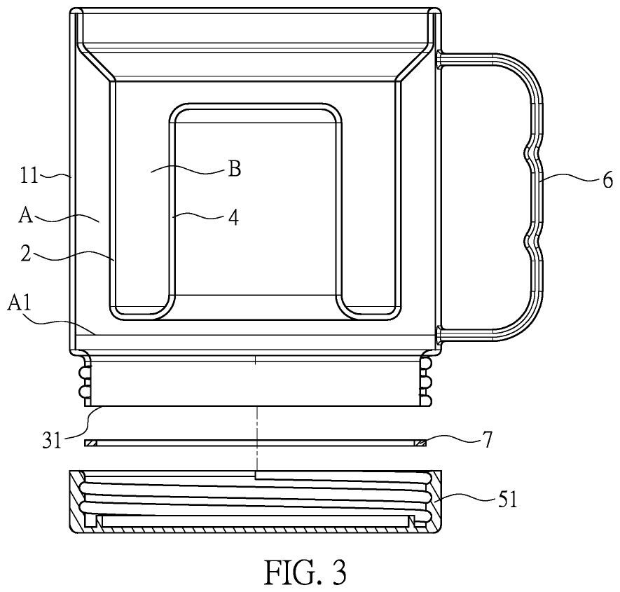

Second Embodiment: As shown in FIG. 3, the outer cup body 1 includes a cup side wall 11; a lower opening 31 for completely opening a bottom of the interlayer inner cavity A is made at a bottom of the cup side wall 11; the lower opening 31 forms the liquid injection port 3; the cover body member 5 includes a screw cap 51 with an internal thread; an external thread fitting an internal thread is disposed on the cup side wall 11; and the screw cap 51 is spirally connected to the lower opening 31 by screw-thread fit. With the larger liquid injection port 3 in this embodiment, the water injection efficiency can be improved.

In addition, in order to ensure seal fit between the screw cap 51 and the lower opening 31, a silicone seal ring 7 can be disposed on the screw cap 51 and made to press against the lower opening for sealing to enhance the seal degree.

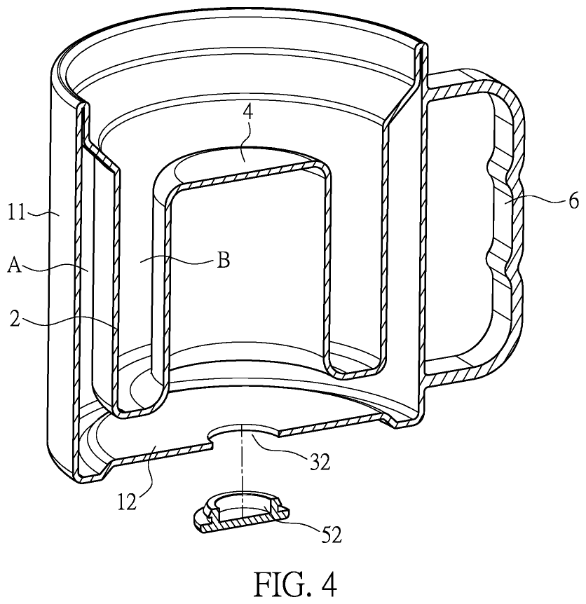

Third Embodiment: As shown in FIG. 4, the outer cup body 1 includes a cup side wall 11 and a cup bottom wall 12; a through hole 32 for communicating the interlayer inner cavity A with the outside is formed on the cup bottom wall 12; the through hole 32 forms the liquid injection port 3; the cover body member 5 is an elastic seal plug 52; and the seal plug 52 is mounted in the through hole 32. In this embodiment, a liquid injection port 3 with a smaller diameter is reserved, and the liquid in the interlayer inner cavity A can be prevented from flowing to cause overflow during the movement of the rapid cooling device; and in liquid freezing, the ice cubes can fill the whole interlayer inner cavity A as much as possible.

In the third embodiment, the through hole 32 can be sealed by the seal plug 52, or, for example, by the screw cap 51 in the second embodiment simply by disposing a thread fitting the screw cap 51 at a position corresponding to the through hole 32.

The convex column 4 extends toward a liquid accommodating cavity B from the bottom wall 21 of the inner cup body 2 or/and the side wall 22 of the inner cup body 2. In this embodiment, preferably, the convex column 4 extends toward the liquid accommodating cavity B from the bottom wall 21 of the inner cup body 2, so that the interlayer inner cavity A can be filled with a liquid more easily without leaving bubbles.

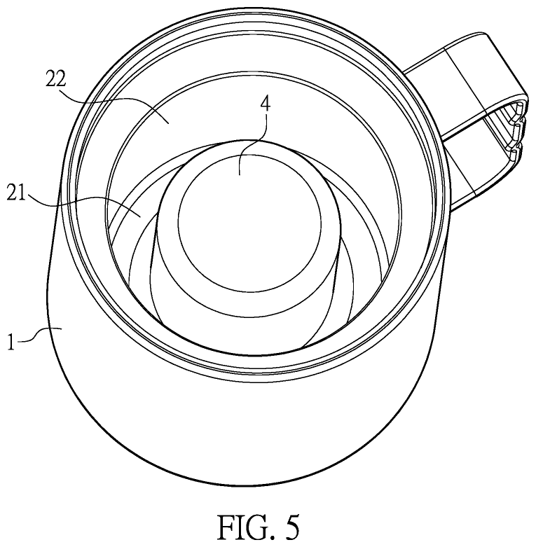

At least one convex column 4 matching a shape of the liquid accommodating cavity B extends from the bottom wall 21 of the inner cup body 2. In this embodiment, as shown in FIG. 5, the liquid accommodating cavity B is round since the rapid cooling device is round, and a cylindrical convex column 4 extends toward the liquid accommodating cavity B from the bottom wall 21 of the inner cup body 2, thereby maximizing the contact area between a beverage and the wall surface and increasing the beverage freezing speed.

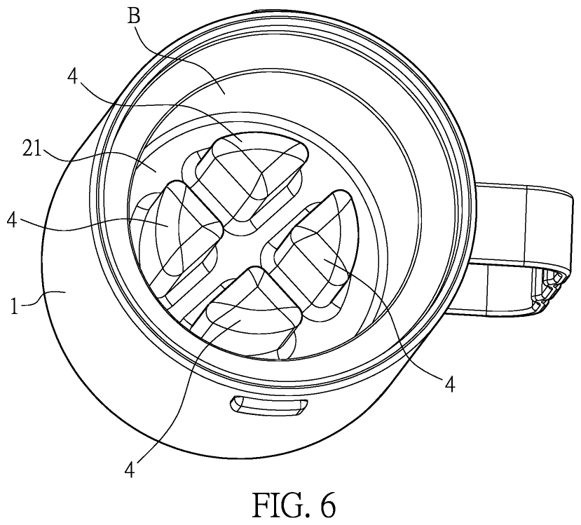

A plurality of convex columns 4 extend toward the liquid accommodating cavity B from the bottom wall 21 of the inner cup body 2, and the convex columns 4 are distributed in a rectangular array or an annular array. As shown in FIG. 6, four convex columns 4 which are disposed at intervals and have fan-shaped cross sections extend toward the liquid accommodating cavity B from the bottom wall 21 of the inner cup body 2, thereby increasing the capacity of the liquid accommodating cavity B and the contact area between the beverage and the wall surface as well as making the structure more beautiful.

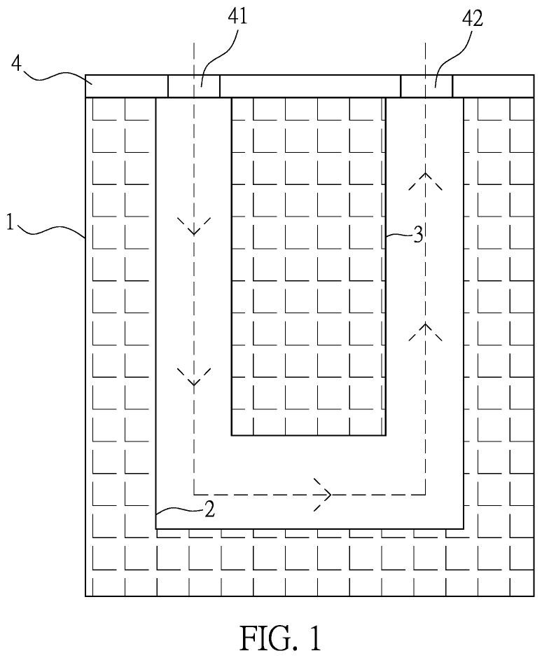

As shown in FIG. 1 or FIG. 2, a maximum liquid level line A1 is disposed on walls of the outer cup body 1 and the inner cup body 2 and corresponding to the interlayer inner cavity A, which can prevent the ice surface from going beyond the liquid injection port 3 so that the cover body member 5 cannot seal the interlayer inner cavity after the liquid in the interlayer inner cavity A is frozen.

A handle 6 is disposed on an outer end surface of the outer cup body 1, and a user can conveniently lift and put down the rapid cooling device by using the handle 6.

In addition, the outer cup body 1 and the inner cup body 2 are both made of a metal material with relatively good thermal conductivity, for example, stainless steel, aluminum, copper or an alloy material including the above-mentioned metals.

A refrigeration method of the rapid beverage cooling device includes the following steps:

step 1: turning the rapid cooling device upside down to make the liquid injection port 3 face upward;

step 2: adding drinking water into the interlayer inner cavity A through the liquid injection port 3 to the maximum liquid level line A1 or below the maximum liquid level line A1;

step 3: putting the rapid cooling device, with the liquid injection port 3 facing upward, into a refrigeration apparatus for cooling;

step 4: waiting for the liquid in the interlayer inner cavity A to be cooled to a frozen state;

step 5: taking the rapid cooling device out of the refrigeration apparatus;

step 6: mounting the cover body member 5 on the liquid injection port 3 to seal the interlayer inner cavity A; and

step 7: pouring a beverage into the liquid accommodating cavity B for cooling.

After the above-mentioned steps are completed, the service state of the rapid cooling device is shown in FIG. 6.

It also should be noted that in the step 2, the interlayer inner cavity A is preferably filled with drinking water such as tap water, distilled water and mineral water; and in the step 3, the refrigeration apparatus may be a household refrigerator.

Preferable solutions of the present disclosure are described above, showing and describing the basic principles, main features and advantages of the present disclosure. Those skilled in the art should understand that the present disclosure is not limited to the above-mentioned embodiments. The description in the above-mentioned embodiments and specification is merely for describing the principles of the present disclosure. Various variations and modifications are possible without departing from the spirit and scope of the present disclosure, and these variations and modifications all fall within the scope of the present disclosure. The scope of the present disclosure is defined by the attached claims and the equivalents thereof.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A rapid beverage cooling device, comprising an outer cup body and an inner cup body of which rims are connected, wherein an interlayer inner cavity for storing a liquid is formed between the outer cup body and the inner cup body; a liquid injection port communicated with the interlayer inner cavity is made at a bottom of the outer cup body; the liquid injection port can be opened or sealed; a liquid accommodating cavity is disposed in the inner cup body; a convex column extends toward the liquid accommodating cavity from a wall of the inner cup body; and an inner cavity of the convex column is communicated with the interlayer inner cavity.

2. The rapid beverage cooling device according to claim 1, wherein a cover body member for closing the interlayer inner cavity is mounted on the liquid injection port.

3. The rapid beverage cooling device according to claim 2, wherein the outer cup body comprises a cup side wall, a lower opening for completely opening a bottom of the interlayer inner cavity is disposed at a bottom of the cup side wall, and the lower opening forms the liquid injection port; or the outer cup body comprises a cup side wall and a cup bottom wall, a through hole for communicating the interlayer inner cavity with the outside is formed on the cup bottom wall, and the through hole forms the liquid injection port.

4. The rapid beverage cooling device according to claim 3, wherein the cover body member comprises a screw cap with an internal thread, or an elastic seal plug; an external thread fitting an internal thread is disposed on the cup side wall; the screw cap is spirally connected to the lower opening by screw-thread fit; and the seal plug is mounted in the through hole.

5. The rapid beverage cooling device according to claim 1, wherein the convex column extends toward the liquid accommodating cavity from the bottom wall of the inner cup body or/and the side wall of the inner cup body.

6. The rapid beverage cooling device according to claim 5, wherein at least one convex column matching a shape of the liquid accommodating cavity extends from the bottom wall of the inner cup body.

7. The rapid beverage cooling device according to claim 5, wherein a plurality of convex columns extend toward the liquid accommodating cavity from the bottom wall of the inner cup body; and the convex columns are distributed in a rectangular array or an annular array.

8. The rapid beverage cooling device according to claim 1, wherein a maximum liquid level line is disposed on walls of the outer cup body and the inner cup body and corresponding to the interlayer inner cavity.

9. The rapid beverage cooling device according to claim 1, wherein a handle is disposed on an outer end surface of the outer cup body.

10. A refrigeration method applicable to the rapid beverage cooling device according to claim 1, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

11. A refrigeration method applicable to the rapid beverage cooling device according to claim 2, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

12. A refrigeration method applicable to the rapid beverage cooling device according to claim 3, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

13. A refrigeration method applicable to the rapid beverage cooling device according to claim 4, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

14. A refrigeration method applicable to the rapid beverage cooling device according to claim 5, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

15. A refrigeration method applicable to the rapid beverage cooling device according to claim 6, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

16. A refrigeration method applicable to the rapid beverage cooling device according to claim 7, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

17. A refrigeration method applicable to the rapid beverage cooling device according to claim 8, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.

18. A refrigeration method applicable to the rapid beverage cooling device according to claim 9, comprising the following steps:
step 1: turning the rapid cooling device upside down to make the liquid injection port face upward;
step 2: adding drinking water into the interlayer inner cavity through the liquid injection port to a maximum liquid level line or below the maximum liquid level line;
step 3: putting the rapid cooling device, with the liquid injection port facing upward, into a refrigeration apparatus for cooling;
step 4: waiting for the liquid in the interlayer inner cavity to be cooled to a frozen state;
step 5: taking the rapid cooling device out of the refrigeration apparatus;
step 6: mounting a cover body member on the liquid injection port to seal the interlayer inner cavity; and
step 7: pouring a beverage into the liquid accommodating cavity for cooling.
